(19) United States
(12) Patent Application Publication
(10) Pub. No.: US 2015/0280226 A1
(43) Pub. Date: Oct. 1, 2015

(54) METHOD FOR MANUFACTURING ELECTRODE FOR BATTERY, APPARATUS FOR MANUFACTURING ELECTRODE FOR BATTERY AND ELECTRODE COMPOSITE

(71) Applicant: SCREEN Holdings Co., Ltd., Kyoto (JP)

(72) Inventor: Kuniko TERAKI, Kyoto (JP)

(21) Appl. No.: 14/554,556

(22) Filed: Nov. 26, 2014

(30) Foreign Application Priority Data
Mar. 25, 2014 (JP) 2014-062286

(51) Int. Cl. H01M 4/36; H01M 10/04; H01M 4/04

(52) U.S. Cl. CPC H01M 4/366; H01M 4/0404; H01M 4/0419; H01M 10/0431

(57) ABSTRACT

An electrode composite having such a structure that a first active material layer and a second active material layer are formed on two principal surfaces of a sheet body functioning as a current collector is formed. Each of the first and the second active material layer includes a plurality of strip-shaped parts which extend in a longitudinal direction of the sheet body and are arranged at a distance from each other. An area of a first principal surface of the sheet body corresponding to a gap between the second strip-shaped parts on a second principal surface is covered by one of the first strip-shaped parts; and an area of the second principal surface of the sheet body corresponding to a gap between the first strip-shaped parts on the first principal surface is covered by one of the second strip-shaped parts.

### CROSS REFERENCE TO RELATED APPLICATION

The disclosure of Japanese Patent Application No. 2014-062286 filed on Mar. 25, 2014 including specification, drawings and claims is incorporated herein by reference in its entirety.

### BACKGROUND OF THE INVENTION

1. Field of the Invention

This invention relates to an electrode composite for battery having such a structure that active material layers are formed on both surfaces of a sheet-like current collector and a manufacturing technology therefor.

2. Description of the Related Art

The applicant of this application previously disclosed a technology for applying an application liquid containing an active material in stripes on a surface of a current collector by a nozzle-scan application technology (JP2011-070788A and US-2011-0070479-A1 for example) as a technology for manufacturing an electrode used in a chemical battery such as a lithium ion secondary battery. In this technology, a nozzle provided with a multitude of discharge ports is arranged to face the current collector and stripe-shaped active material pattern elements are formed on the surface of the current collector by relatively moving the current collector and the nozzle while discharging the application liquid from each discharge port. According to such a manufacturing method, active material pattern elements having various cross-sectional shapes and dimensions can be formed with good controllability. Further, since a surface area with respect to a used active material quantity can be increased in a structure formed in this way, it is possible to form an electrode with good charging/discharging characteristics.

To further increase the capacity of such an electrode for battery or to enable large-scale industrial production, a room for improvement is left in the above conventional technology. For example, it is considered to form active material layers on both surfaces of a current collector to increase the capacity of an electrode. Further, it is necessary to form an active material layer on a current collector sheet having a large area to industrially produce electrodes and considerations need to be taken on the handling of such a sheet having a large area. However, in the above conventional technology, a consideration on a specific technology for manufacturing electrodes in such modes is inadequate. Thus, it is desired to establish a technology capable of stably producing a high-capacity electrode for battery.

### SUMMARY OF THE INVENTION

This invention was developed in view of the above problem and aims to provide a technology capable of stably producing an electrode for battery structured such that active material layers are formed on both surfaces of a sheet-like current collector.

A method for manufacturing an electrode for battery according to the present invention comprises: an arranging step of conveying a sheet body, which functions as a current collector, in a predetermined direction, causing a first nozzle with a plurality of first discharge ports arranged along a width direction of the sheet body perpendicular to the conveying direction of the sheet body to face a first principal surface of the sheet body and causing a second nozzle with a plurality of second discharge ports arranged along the width direction to face a second principal surface of the sheet body opposite to the first principal surface; a first applying step of discharging a first application liquid containing an active material from each of the first discharge ports of the first nozzle to form a first active material layer including a plurality of first strip-shaped parts extending along the conveying direction on the first principal surface; and a second applying step of discharging a second application liquid containing an active material from each of the second discharge ports of the second nozzle to form a second active material layer including a plurality of second strip-shaped parts extending along the conveying direction on the second principal surface, wherein: an area of the first principal surface of the sheet body corresponding to a gap between the second strip-shaped parts on the second principal surface is covered by one of the first strip-shaped parts; and an area of the second principal surface of the sheet body corresponding to a gap between the first strip-shaped parts on the first principal surface is covered by one of the second strip-shaped parts.

In the thus configured invention, the active material layers are formed on the both surfaces of the sheet body. The active material layer (first active material layer, second active material layer) formed on each surface is so structured that the plurality of strip-shaped parts (first strip-shaped parts, second strip-shaped parts) extending in the sheet conveying direction are arranged at a distance from each other on the sheet body surface. Here, the sheet body is exposed between adjacently arranged strip-shaped parts and mechanical strength is lower in such parts than in parts where the strip-shaped parts are formed on the surface(s).

Thus, if such a sheet body is subjected to an external force, a stress tends to concentrate on the exposed part of the sheet body and the electrode tends to be deflected or bent in this part. Such an external force acts, for example, when the formed electrode for battery is wound into a roll or in a working process until a battery is completed. Particularly, in the case of forming the active material layers on the both surfaces of the sheet body, a strength difference between parts strong against external forces and parts weak against external forces becomes notable if the strip-shaped parts are formed on the same positions on the both surfaces, wherefore bending or breakage may occur in the weak parts.

Contrary to this, in the invention, out of the both principal surfaces of the sheet body, in a part of the sheet body which corresponds to the gap between the first strip-shaped parts and where the first principal surface is exposed, the second principal surface is covered by the second strip-shaped parts. Further, in a part which corresponds to the gap between the second strip-shaped parts and where the second principal surface is exposed, the first principal surface is covered by the first strip-shaped parts. Thus, in each part of the sheet body, the strip-shaped part is formed at least on either one of the surfaces. Thus, the sheet body is not exposed on the both surfaces and, in the parts exposed on one sheet body surface, strength is complementarily ensured by the strip-shaped parts on the other surface. Therefore, a local stress concentration on the sheet body can be avoided, and the electrode for battery can be stably manufactured by preventing bending and breakage due to the action of an external force in the manufacturing process.

Further, an apparatus for manufacturing an electrode for battery according to the present invention comprises: a conveyor for conveying a sheet body which becomes a current collector; a first nozzle which includes a plurality of first discharge ports arranged in a row to discharge a first application liquid containing an active material and is arranged such that an arrangement direction of the first discharge ports is perpendicular to a conveying direction of the sheet body conveyed by the conveyor and that each of the plurality of first discharge port faces a first principal surface of the sheet body; and a second nozzle which includes a plurality of second discharge ports arranged in a row to discharge a second application liquid containing an active material and is arranged such that an arrangement direction of the second discharge ports is parallel to the arrangement direction of the first discharge ports and that each of the plurality of second discharge port faces a second principal surface of the sheet body opposite to the first principal surface, wherein when the first discharge ports and the second discharge ports are projected onto a virtual plane perpendicular to the conveying direction, a range of an area corresponding to a gap part between two first discharge ports adjacent to each other is included in an opening range of one of the second discharge ports and a range of an area corresponding to a gap part between two second discharge ports adjacent to each other is included in an opening range of one of the first discharge ports in a direction parallel to the arrangement direction within the virtual plane of projection.

In the thus configured invention, a plurality of strip-shaped pattern elements of the active material extending along the conveying direction of the sheet body are formed on the first principal surface by the first application liquid discharged from the plurality of first discharge ports arranged on the first nozzle. On the other hand, a plurality of strip-shaped pattern elements of the active material extending along the conveying direction of the sheet body are formed on the second principal surface by the second application liquid discharged from the plurality of second discharge ports arranged on the second nozzle. The first application liquid is not applied in a gap area of the first principal surface of the sheet body corresponding to the gap part between adjacent first discharge ports, whereby the first principal surface is exposed. However, the second discharge ports of the second nozzle are arranged in an area of the second principal surface corresponding to the gap area and the second application liquid is applied to form the strip-shaped pattern elements. Since the opening ranges of the second discharge ports are wider than the gap between the first discharge ports, the strip-shaped pattern elements wider than the gap between the pattern elements on the first principal surface are formed on the second principal surface. In an area corresponding to the gap on the second principal surface, the strip-shaped pattern elements are formed on the first principal surface. Therefore, as in the above invention relating to the manufacturing method, an electrode for battery, the bending and breakage of which due to local stress concentration on the sheet body are prevented, can be stably manufactured.

Further, an electrode composite according to the present invention have such a structure that active material layers are formed on both surfaces of a current collector in the form of a long sheet and comprises: a sheet body for functioning as the current collector; a first active material layer including a plurality of first strip-shaped parts which extend in a longitudinal direction of the sheet body along a first principal surface of the sheet body and are arranged at a distance from each other in a direction perpendicular to the longitudinal direction; and a second active material layer including a plurality of second strip-shaped parts which extend in the longitudinal direction along a second principal surface of the sheet body opposite to the first principal surface and are arranged at a distance from each other in a direction perpendicular to the longitudinal direction, wherein: an area of the first principal surface of the sheet body corresponding to a gap between the second strip-shaped parts on the second principal surface is covered by one of the first strip-shaped parts; an area of the second principal surface of the sheet body corresponding to a gap between the first strip-shaped parts on the first principal surface is covered by one of the second strip-shaped parts; and the electrode composite is wound into a roll around a winding axis perpendicular to the longitudinal direction.

In the thus configured invention, the second strip-shaped parts are formed on the second principal surface to correspond to the gap between adjacent first strip-shaped parts on the first principal surface of the sheet body. On the other hand, the first strip-shaped parts are formed on the first principal surface to correspond to the gap between adjacent second strip-shaped parts on the second principal surface of the sheet body. Specifically, the second strip-shaped parts are provided on the second principal surface to enhance mechanical strength in parts with low mechanical strength on the first principal surface, whereas the first strip-shaped parts are provided on the first principal surface to enhance mechanical strength in parts with low mechanical strength on the second principal surface. By complementarily ensuring mechanical strength on the both principal surfaces of the sheet body in this way, the electrode composite has no parts with extremely low strength. Therefore, even if the electrode composite is wound, local deflection, bending and the like of the sheet body due to stress concentration can be effectively prevented.

This composite for electrode is cut to a predetermined size and functions as an electrode for battery. Since the deformation of the sheet body due to winding is prevented, performance degradation due to the deformation of the sheet body can be prevented in industrially manufacturing electrodes for battery and batteries using this composite. Therefore, the electrodes for battery and batteries can be stably manufactured.

According to the invention, it is possible to manufacture an electrode for battery structured such that the active material layers are formed on the both surfaces of the sheet-like current collector and strength is maintained by the active material layer formed on the other principal surface in parts where one principal surface of the sheet body is exposed. Thus, electrodes for battery can be stably manufactured by preventing local deformation of the sheet body also in such a phase where stresses act such as due to winding in a later process.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIGS. 1A to 1C are diagrams showing a schematic configuration of one embodiment of an apparatus for manufacturing an electrode for battery according to this invention.

FIGS. 2A to 2C are views diagrammatically showing the application liquid applied on the sheet.

FIGS. 3A to 3C are diagrams showing the configuration of the application nozzles in more detail.

FIGS. 4A to 4E are diagrams showing examples of a cross-sectional structure of an electrode composite.

FIGS. 5A to 5D are sectional views illustrating other shapes of active material layers.

### DETAILED DESCRIPTION OF THE PREFERRED EMBODIMENTS

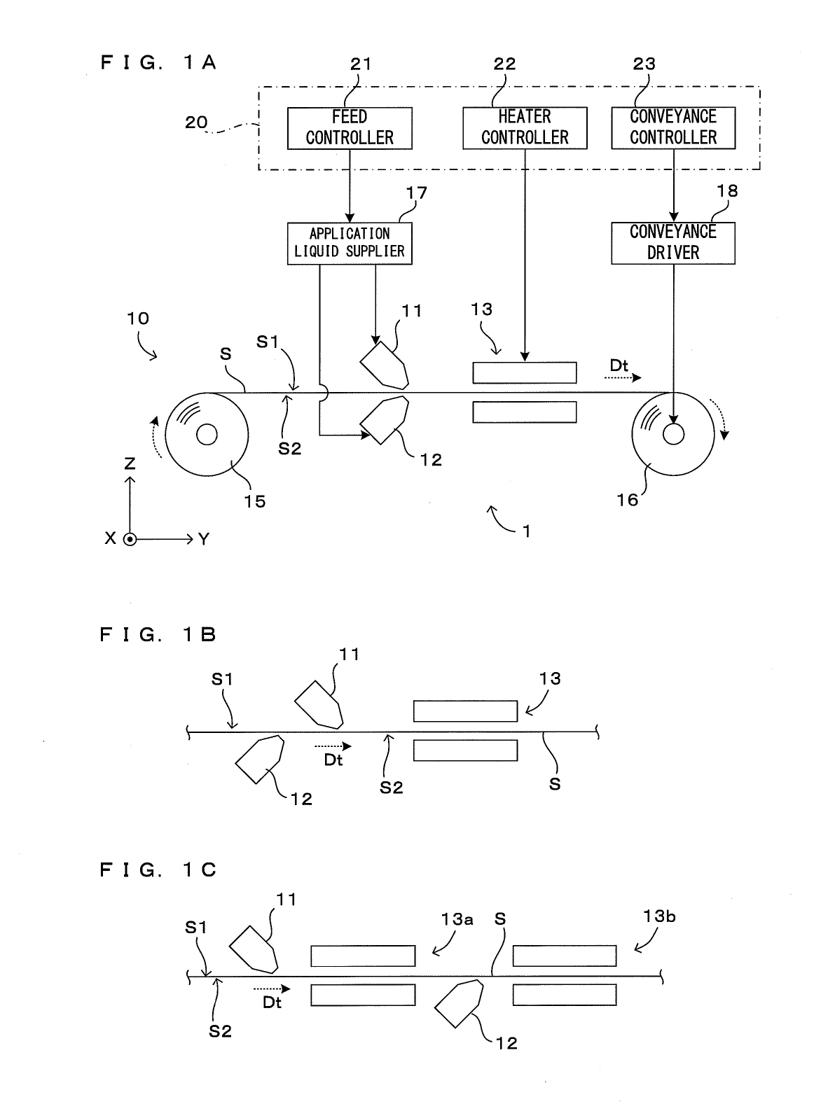

FIGS. 1A to 1C are diagrams showing a schematic configuration of one embodiment of an apparatus for manufacturing an electrode for battery according to this invention. The apparatus 1 for manufacturing an electrode for battery (hereinafter, abbreviated as an “electrode manufacturing apparatus”) shown in FIG. 1A includes a manufacturing unit 10 as an operation subject of a manufacturing process for an electrode for battery used, for example, as an electrode of a lithium ion secondary battery and a control unit 20 for controlling the manufacturing unit 10. The electrode manufacturing apparatus 1 is an apparatus for manufacturing an electrode composite for battery, in which a current collector and active material layers are laminated. The electrode manufacturing apparatus 1 applies an application liquid containing the active material on both surfaces of a sheet S as a base material and thereby forms the active material layers. The sheet S made of metal functions as the current collector in a completed battery. Note that a single metal foil or thin plate may be used as the sheet S or a metal foil attached, for example, to a resin sheet as a carrier or the one formed by chemically depositing metal can be suitably used.

XYZ coordinate axes are set as shown in FIG. 1A for the following description. Here, an XY plane is a horizontal plane and a Z axis coincides with a vertical axis. A positive direction on the Z axis is a vertically upward direction.

The manufacturing unit 10 includes a supply roller 15 for holding the rolled sheet S before active material layer formation and feeding the sheet S at a constant speed and a winding roller 16 for winding the sheet S after the active material layers are formed. The sheet S is stretched between these rollers and conveyed at the constant speed in a direction of an arrow Dt as the rollers rotate. In an example of FIG. 1A, each of the supply roller 15 and the winding roller 16 has an axis of rotation parallel to the X axis and the sheet S is conveyed in a direction parallel to the Y axis by the rotation of the rollers 15, 16 in response to a drive signal from a conveyance driver 18. Specifically, in this example, the conveying direction Dt of the sheet S is a Y direction. The conveyance driver 18 drives the rollers 15, 16 to convey the sheet S in response to a control command from a conveyance controller 23 provided in the control unit 20.

Application nozzles 11, 12 and a drying unit 13 are arranged along a conveyance path of the sheet S conveyed in the conveying direction Dt. The application nozzle 11 is provided at the side of an upper surface S1 of the sheet S. On the other hand, the other application nozzle 12 is provided at the side of a lower surface S2 of the sheet S. The drying unit 13 includes a pair of heaters arranged at opposite upper and lower sides of the sheet S at a position downstream of the application nozzles 11, 12 in the conveying direction Dt of the sheet S. Thus, if attention is focused on one point on the upper surface S1 of the sheet S, this point successively passes over a position facing the application nozzle 11 and a position facing the drying unit 13 after being fed out from the supply roller 15. Further, if attention is focused on one point on the lower surface S2 of the sheet S, this point successively passes over a position facing the application nozzle 12 and a position facing the drying unit 13 after being fed out from the supply roller 15.

The application nozzle 11 applies a paste-like application liquid containing an active material to the upper surface S1 of the sheet S upon receiving the supply of the application liquid fed under pressure from an application liquid supplier 17. Further, the application nozzle 12 applies a paste-like application liquid containing an active material to the lower surface S2 of the sheet S upon receiving the supply of the application liquid fed under pressure from the application liquid supplier 17. The application liquid supplier 17 is controlled by a feed controller 21 provided in the control unit 20.

The application liquid supplier 17 includes s storage part for storing the application liquids and a liquid feeding part such as a Mohno pump in charge of feeding the application liquid under pressure to the application nozzles 11, 12 in response to a control command from the feed controller 21 and stopping the pressure feed. Although described in detail later, discharge ports for feeding the application liquid are provided on the lower surface of the application nozzle 11 and the application liquid can be continuously fed from the discharge ports. Further, the application nozzle 12 is provided at a position facing the application nozzle 11 via the sheet S at the side of the lower surface S2 of the sheet S. Discharge ports for feeding the application liquid are provided on the upper surface of the application nozzle 12 and the application liquid can be continuously fed from the discharge ports.

The drying unit 13 is controlled to a predetermined temperature by a heater controller 22 provided in the control unit 20. The drying unit 13 heats the application liquid applied on the surfaces of the sheet S from the application nozzles 11, 12 to promote drying and solidification. The dried sheet S is wound into a roll by the winding roller 16.

Materials used in the above manufacturing process are as follows for example. With respect to the process for manufacturing a positive electrode of the lithium-ion secondary battery, an aluminum foil may for instance be used as the sheet S to become a positive current collector. For the positive active material, a known positive active material such as a material mainly containing LiCoO₂ (LCO), LiNiO₂, LiFePO₄, LiMnPO₄, LiMn₂O₄ or compounds represented by LiMeO₂ (Me=MₓM_{y}M_{z}; Me, M are transition metal elements and x+y+z=1) such as LiNi_{1/3}Mn_{1/3}Co_{1/3}O₂ and LiNi_{0.8}Co_{0.15}A1_{0.05}O₂ can be used.

Further, with respect to the process for manufacturing a negative electrode of the lithium-ion secondary battery, a copper foil may for instance be used as the sheet S to become a negative current collector. A material mainly containing Li₄Ti₅O₁₂ (LTO), C, Si (or compounds containing at least one of these elements) or Sn can be, for example, used as the negative active material.

As the application liquid containing the active material, a mixture of the active material, acetylene black or ketjen black as a conduction aid, polyvinylidene fluoride (PVDF), styrene butadiene rubber (SBR), polyvinyl pyrrolidone (PVP), polyvinyl alcohol (PVA) or polytetrafluoroethylene (PTFE) as a binder, N-methyl-2-pyrrolidone (NMP) as a solvent and the like can be used.

The viscosity of the application liquid obtained by mixing such materials can be appropriately adjusted by changing a composition ratio. Paste having a viscosity of, e.g. 10 Pa·s to 10000 Pa·s is preferable as the application liquid for forming a structure by being continuously fed from the application nozzles 11, 12 as in this embodiment.

Note that, in a configuration example of FIG. 1A, the application nozzle 11 provided to face the upper surface S1 of the sheet S and the application nozzle 12 provided to face the lower surface S2 of the sheet S are provided at the same position in the sheet conveying direction Dt. Instead of this, the application nozzle 11 at the side of the sheet upper surface S1 and the application nozzle 12 at the side of the sheet lower surface S2 may be arranged at different positions in the sheet conveying direction Dt, for example, as shown in FIG. 1B. Further, as shown in FIG. 1C, a drying unit 13a may be provided at a position downstream of the application nozzle 11 in the conveying direction Dt to dry the application liquid applied from the application nozzle 11 at the side of the sheet upper surface S1 and a drying unit 13b may be provided at a position downstream of the application nozzle 12 in the conveying direction Dt to dry the application liquid applied from the application nozzle 12 at the side of the sheet lower surface S2.

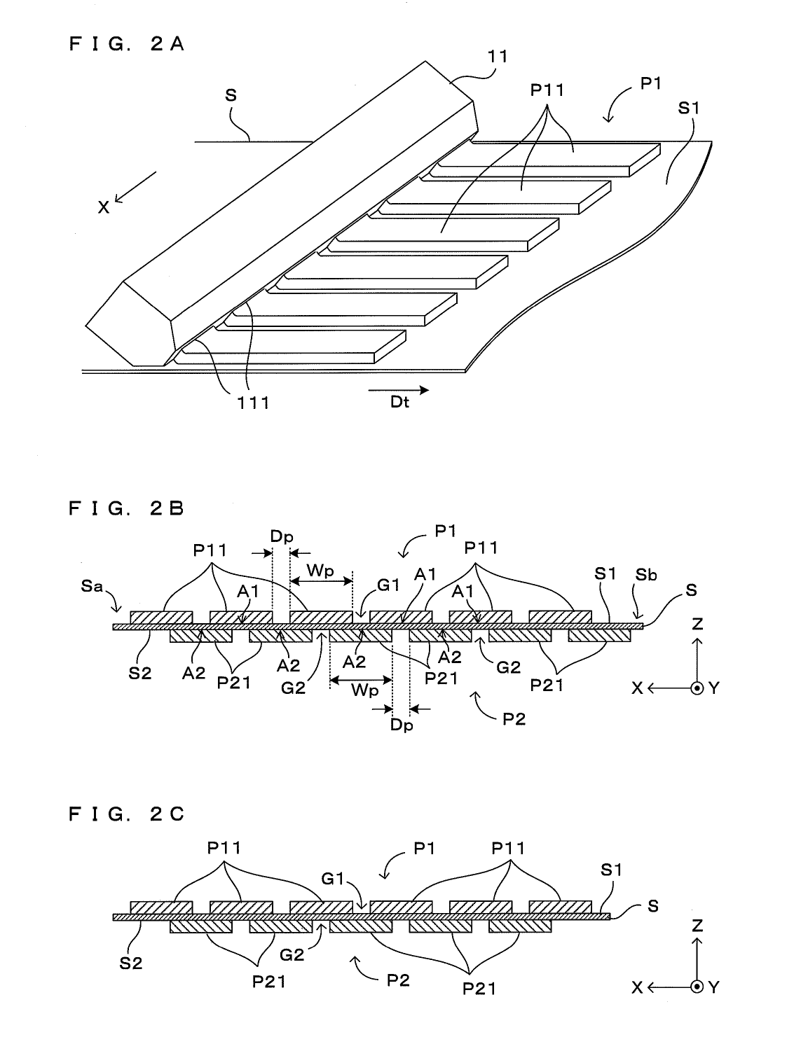

FIGS. 2A to 2C are views diagrammatically showing the application liquid applied on the sheet. As shown in FIG. 2A, the application nozzle 11 has a long and narrow shape. A longitudinal direction of the application nozzle 11 is a width direction of the sheet S perpendicular to the sheet conveying direction Dt. Therefore, the longitudinal direction is an X direction in this embodiment. A plurality of slit-like discharge openings 111 are provided side by side in the X direction on a lower part of the application nozzle 11. The application nozzle 11 is arranged proximate to the sheet S so that each discharge port 111 faces one surface (upper surface) S1 of the sheet S. Each discharge port 111 has the same shape and the application liquid fed under pressure from the application liquid supplier 17 is applied on the sheet upper surface S1 from these discharge ports 111. In this way, a plurality of strip-shaped pattern elements P11 made of the active material are formed on the sheet upper surface S1.

The respective strip-shaped pattern elements P11 formed in this way have a strip shape having a longitudinal direction in the Y direction equal to the sheet conveying direction Dt, have cross-sectional shapes long and narrow in the X direction and equal to each other, and are arranged in parallel on the sheet upper surface S1 at regular intervals in the X direction. The strip-shaped pattern elements P11 are dried and solidified by the drying unit 13, whereby an active material layer P1 is formed on the sheet upper surface S1.

Although not shown in FIG. 2A, the application nozzle 12 is provided to face the sheet lower surface S2 similarly to the above. Strip-like pattern elements made of the active material are also formed on the sheet lower surface S2 by the application liquid discharged from the application nozzle 12. As shown in a sectional view of FIG. 2B, the positions in the X direction of the strip-shaped pattern elements P21 constituting an active material layer P2 formed on the sheet lower surface S2 are shifted in the X direction from the strip-shaped pattern elements P1 by half the arrangement interval of the strip-shaped pattern elements P1 formed on the sheet upper surface S1.

A pattern element width Wp and a pattern element interval Dp are equal on the upper surface S1 and the lower surface S2 of the sheet S. Further, the pattern element width Wp is larger than the pattern element interval Dp. Thus, an area A2 of the lower surface S2 corresponding to a gap area G1 of the sheet upper surface S1 having a surface exposed by being located between two adjacent strip-shaped pattern elements P11 is covered by the strip-shaped pattern element P21. Similarly, an area A1 of the upper surface S1 corresponding to a gap area G2 of the sheet lower surface S2 having a surface exposed by being located between two adjacent strip-shaped pattern elements P21 is covered by the strip-shaped pattern element P11.

In the X direction, each strip-shaped pattern element P 11 on the sheet upper surface S1 extends further outward than opposite end parts of the corresponding gap area G2 on the sheet lower surface S2. Similarly, each strip-shaped pattern element P21 on the sheet lower surface S2 extends further outward than opposite end parts of the corresponding gap area G1 on the sheet upper surface S1. Thus, except at opposite end parts Sa, Sb of the sheet S in the X direction, at least one of the upper surface S1 and the lower surface S2 is covered by the active material in each part of the sheet S and there is no part exposed on both surfaces.

Note that although the same number of strip-shaped pattern elements are formed on the upper surface S1 and the upper surface S1 of the sheet S in the example shown in FIG. 2B, there is no limitation to this. For example, as shown in FIG. 2C, the number of pattern elements may differ on the upper and lower surfaces. However, also in this case, areas on the sheet lower surface S2 corresponding to the gap areas G1 are covered by the strip-shaped pattern elements P21, and areas on the sheet upper surface 51 corresponding to the gap areas G2 are covered by the strip-shaped pattern elements P11.

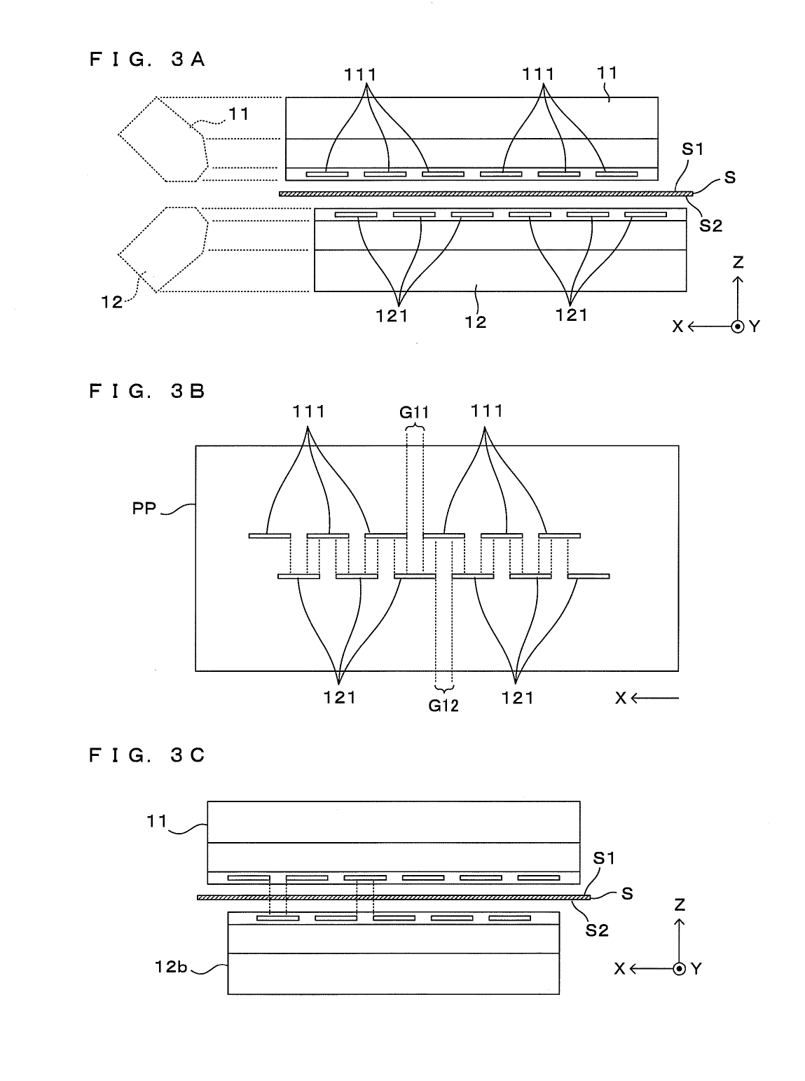

FIGS. 3A to 3C are diagrams showing the configuration of the application nozzles in more detail. As shown in FIG. 3A, a plurality of discharge ports 111 open toward the sheet upper surface S1 are provided on a lower part of the application nozzle 11 arranged to face the upper surface S1 of the sheet S. On the other hand, a plurality of discharge ports 121 open toward the sheet lower surface S2 are provided on an upper part of the application nozzle 12 arranged to face the lower surface S2 of the sheet S.

A case of projecting the discharge ports 111, 121 of the application nozzles 11, 12 onto an XZ plane perpendicular to the sheet conveying direction Dt (Y direction) is considered. This plane of projection PP is shown in FIG. 3B. In the X direction of this plane of projection PP, a range of a gap G11 between the discharge ports 111 of the application nozzle 11 is completely included in an opening range of one discharge port 121 of the facing application nozzle 12. On the contrary, a range of a gap G12 between the discharge ports 121 of the application nozzle 12 is completely included in an opening range of one discharge port 111 of the facing application nozzle 11. By arranging the discharge ports 111, 121 provided on the application nozzles 11, 12 in this way, a structure shown in FIG. 2B can be formed. In this case, apparatus cost can be reduced since the application nozzles 11, 12 can be identically structured.

On the other hand, by making the shape of one application nozzle 12b different as shown in FIG. 3C, a structure shown in FIG. 2C can be formed. Also in this case, a gap between the discharge ports of one application nozzle is included in an opening range of one discharge port of the other application nozzle.

A positional relationship of the discharge ports in the sheet conveying direction Dt is arbitrary. Even in the case where the positions of the application nozzles differ in the sheet conveying direction Dt as exemplified in FIGS. 1B and 1C, the positional relationship thereof can be considered as in the above case by projecting the discharge ports of the both nozzles onto a virtual plane (XZ plane in this example) perpendicular to the sheet conveying direction Dt.

As just described, the electrode manufacturing apparatus 1 of this embodiment forms the active material layers P1, P2 on the both surfaces of the sheet S respectively. In this way, an electrode composite is formed which functions as an electrode by being incorporated into a lithium ion secondary battery. The electrode composite is wound into a roll by the winding roller 16 and served in a battery manufacturing process. As described above, the electrode composite manufactured by this apparatus 1 is so structured that areas corresponding to gaps between the strip-shaped pattern elements on one surface are covered by the strip-shaped pattern elements on the other surface. Why such a structure is employed is described next.

By forming active material layers on both surfaces of a sheet which functions as a current collector, the capacity of an electrode can be increased. In this case, by making the surfaces of the active material layers formed on the both surfaces uneven, it is possible to improve charging/discharging characteristics by making surface areas larger than flat active material layers. The active material layers P1, P2 made of the plurality of strip-shaped pattern elements P11, P21 shown in FIGS. 2B, 2C also have such characteristics.

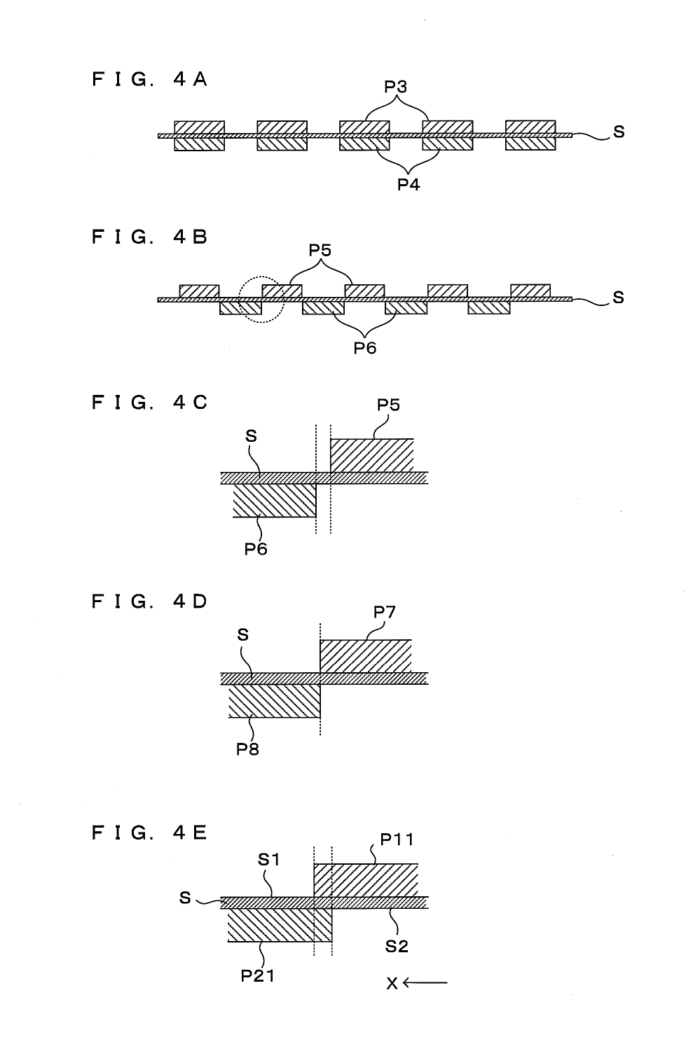

FIGS. 4A to 4E are diagrams showing examples of a cross-sectional structure of an electrode composite. In forming strip-shaped pattern elements on the both surfaces of the sheet S, it may be considered to form strip-shaped pattern elements P3, P4 at the same positions on the both surfaces of the sheet S, as shown in FIG. 4A as a comparative example. Further, as shown in FIG. 4B as another comparative example, it may be also considered to form strip-shaped pattern elements P5, P6 at mutually different positions on the both surfaces of the sheet S. FIG. 4C is a diagram enlargedly showing a part enclosed by dotted line in FIG. 4B, and there is a gap between an area covered by the pattern element P5 on the sheet upper surface and an area covered by the pattern element P6 on the sheet lower surface.

In these comparative examples, areas exposed without being covered by the strip-shaped pattern elements on either surface of the sheet S are present between the strip-like pattern elements formed on the both surfaces. Such exposed areas are apparently inferior in mechanical strength to areas where the strip-shaped pattern element is formed at least on one surface. Thus, when the sheet is wound by the winding roller 16 after application, a stress may concentrate on such an exposed area and the sheet S may be deflected or broken. The deflection of the sheet S causes the active material layers formed on the surfaces thereof to be destroyed or peeled off, thereby reducing performance as an electrode.

Also when an end part of a pattern element P7 formed on one surface of the sheet S and an end part of a pattern element P8 formed on the other surface are located at the same position as shown in FIG. 4D, mechanical strength is reduced and deflection or destruction tends to occur in this part.

In this embodiment shown in FIG. 4E, the strip-shaped pattern elements P11 formed on the one surface (upper surface) S1 of the sheet S and the strip-shaped pattern elements P21 formed on the other surface (lower surface) S2 are so formed as to partly overlap in the X direction. Thus, the sheet S is reinforced by the strip-shaped pattern elements formed at least on one surface, and the exposure of the both surfaces of the sheet S is avoided. Since the areas corresponding to the gaps between the strip-shaped pattern elements on one surface are complementarily reinforced by the strip-shaped pattern elements formed on the other surface in this way, deflection and breakage when the formed electrode composite is wound are effectively prevented. Further, by employing such a structure, it is possible to prevent the breakage of the electrode composite and facilitate handling in each process until a battery is completed.

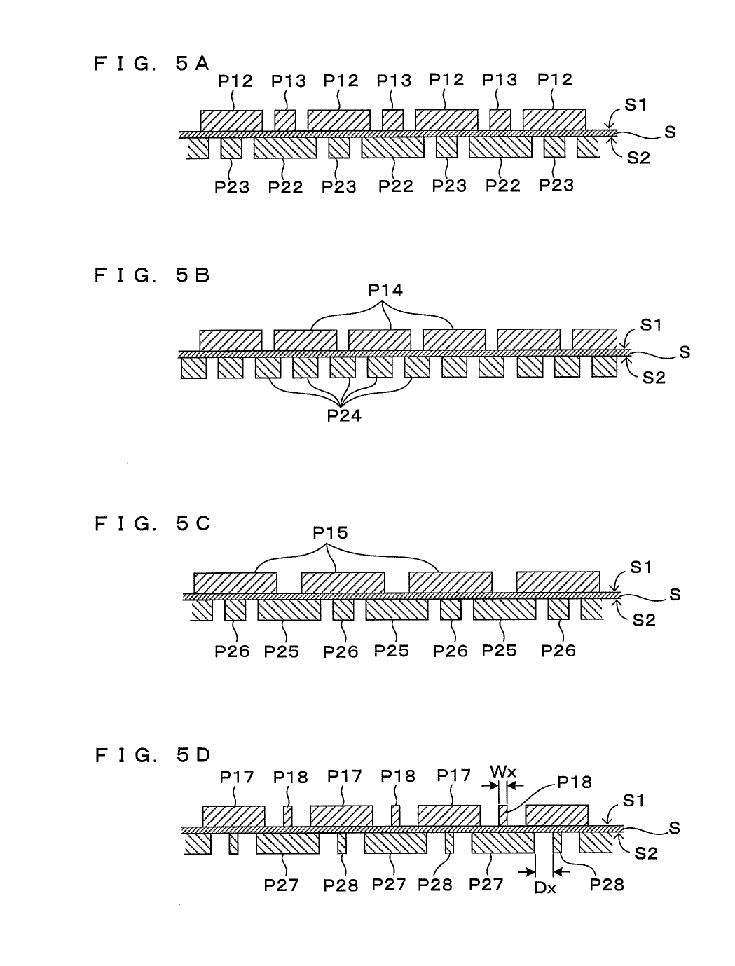

FIGS. 5A to 5D are sectional views illustrating other shapes of active material layers. In the electrode composite described above, any of the plurality of pattern elements P11 formed on the one surface S1 of the sheet S and the plurality of pattern elements P21 formed on the other surface S2 has the same shape. However, the shapes of the pattern elements are not limited to this and structures shown in each of the examples of FIGS. 5A to 5D may be employed. Note that although only cross-sectional shapes of the pattern elements are shown in each example, it is assumed that any of the pattern elements extends in a direction perpendicular to the plane of each figure while keeping a constant cross-sectional shape.

In the example shown in FIG. 5A, relatively wide pattern elements P12 and narrower pattern elements P13 are arranged alternately and at equal intervals in the X direction on the upper surface S1 of the sheet S. On the other hand, pattern elements P22 having the same cross-sectional shape as the pattern elements P12 and pattern elements P23 having the same cross-sectional shape as the pattern elements P13 are arranged alternately and at equal intervals in the X direction on the lower surface S2. Even in this case, at least one surface of the sheet S is covered by the pattern elements to avoid the exposure of both surfaces of the sheet S by making pattern element arrangement positions different in the X direction on the both surfaces.

In the example shown in FIG. 5B, relatively wide pattern elements P14 are arranged on the upper surface S1 of the sheet S, whereas narrower pattern elements P24 are arranged on the lower surface S2 of the sheet S. In the example shown in FIG. 5C, relatively wide pattern elements P15 having the same cross-sectional shape are arranged on the upper surface S1 of the sheet S, whereas relatively wide pattern elements P25 and narrower pattern elements P26 are alternately arranged on the lower surface S2. Even in the case where the pattern elements have different shapes on the both surfaces, it is possible to employ a structure in which at least one surface of the sheet S is covered by the pattern element by appropriately setting the pattern element width and the pattern element interval on each surface.

As just described, various shapes and arrangements of the pattern elements are conceivable. In any case, deflection and breakage when the electrode composite is wound can be prevented by adopting such a pattern element arrangement that at least one surface is covered with the active material at each position of the sheet S as in each of the above examples. A structure satisfying the following condition is more preferable.

An example shown in FIG. 5D is equivalent to the example of FIG. 5A in which the widths of the pattern elements P13, P23 are narrower. Specifically, relatively wide pattern elements P17 and narrower pattern elements P18 are alternately arranged on the upper surface S1 of the sheet S. On the other hand, relatively wide pattern elements P27 and narrower pattern elements P28 are alternately arranged on the lower surface S2. Also in this example, a condition that “areas corresponding to gaps between pattern elements on one surface are reinforced by pattern elements on the other surface” is satisfied.

However, in this case, a pattern element width Wx of the pattern elements P18 on the upper surface 51 is smaller than a pattern element interval Dx on the lower surface S2. Similarly, a pattern element width of the pattern elements P28 on the lower surface S2 is smaller than a pattern element interval on the upper surface S1. In such a pattern shape, the pattern elements in a certain layer may be fitted into gaps between pattern elements in a layer adjacent to the former layer in the electrode composite rolled to have many overlapping layers. This may cause the deformation of the sheet S.

To avoid such a problem, it is more preferable that the smallest width of the pattern elements formed on one surface is larger than a maximum value of the gaps between the pattern elements formed on the other surface, i.e. Wx>Dx. This condition is also satisfied in any of the examples shown in FIGS. 2B, 2C, 5A to 5C.

As described above, in the structure for electrode in this embodiment, the sheet S corresponds to a “sheet body” of the invention. The upper surface 51 of the sheet S corresponds to a “first principal surface” and the strip-shaped pattern elements P 11 correspond to “first strip-shaped parts” of the invention, whereas the active material layer P1 corresponds to a “first active material layer” of the invention. On the other hand, the lower surface S2 of the sheet S corresponds to a “second principal surface”, the strip-shaped pattern elements P21 correspond to “second strip-shaped parts” of the invention, the active material layer P2 corresponds to a “second active material layer” of the invention.

Further, in the electrode manufacturing apparatus 1 of the above embodiment, the supply roller 15 and the winding roller 16 integrally function as a “conveyor” of the invention, wherein the winding roller 16 functions as a “winder” of the invention. Further, the application nozzle 11 functions as a “first nozzle” of the invention and the discharge ports 111 correspond to “first discharge ports” of the invention. Further, the application nozzle 12 functions as a “second nozzle” of the invention and the discharge ports 121 correspond to “second discharge ports” of the invention. In this embodiment, a “first application liquid” and a “second application liquid” have the same composition.

As described above, the invention may be, for example, so configured that a first applying step and a second applying step are simultaneously performed by arranging the first and second nozzles to face each other across the sheet body. According to such a configuration, application is performed on both surfaces of the sheet body at the same position in a conveying direction of the sheet body, wherefore a space necessary for manufacturing can be reduced.

Further, the invention may be, for example, so configured that the width of each of the plurality of first strip-shaped parts is larger than a maximum interval between the second strip-shaped parts on the second principal surface and the width of each of the plurality of second strip-shaped parts is larger than a maximum interval between the first strip-shaped parts on the first principal surface. According to such a configuration, the deflection of the sheet body caused by the strip-shaped parts being fitted into gaps can be prevented, for example, when the sheet body formed with the active material layers on both surfaces is folded.

Further, the invention may be, for example, so configured as to include a step of winding the sheet body formed with the first and second active material layers around an axis perpendicular to the conveying direction. According to such a configuration, it is possible to continuously manufacture electrodes for battery having a large area using the long sheet body. Since deflection and unintended deformation are prevented even in this case when the sheet body is wound, it is possible to manufacture electrodes for battery with stable quality.

Further, the invention may be, for example, so configured that the first and second discharge ports are located at the same position in the conveying direction. According to such a configuration, the entire apparatus can be reduced in size since the active material layers can be formed on the both surfaces of the sheet body at the same position in the conveying direction.

Further, the invention may be, for example, so configured that the first and second nozzles have the same shape. According to such a configuration, apparatus cost can be reduced since two nozzles can be commonly designed.

Further, in the invention, the conveyor may be configured to include a winder for winding the sheet body on which the first and second application liquids are applied into a roll. As described above, a force applied when the sheet body is wound may deflect or bend the sheet body, but the deformation of the sheet body can be prevented by the active material layers formed on the both surfaces of the sheet body according to the configuration of the invention.

Further, in the invention, the width of each of the plurality of first strip-shaped parts may be larger than the maximum interval between the second strip-shaped parts on the second principal surface and the width of each of the plurality of second strip-shaped parts may be larger than the maximum interval between the first strip-shaped parts on the first principal surface. According to such a configuration, it is prevented that the strip-shaped parts constituting one layer are fitted into gaps between the strip-shaped parts in an adjacent layer in the structure for electrode wound to have many overlapping layers. In this way, the deformation of the sheet body can be more effectively prevented.

Furthermore, in the invention, the sheet body may be formed of a material which functions as a current collector of a lithium ion secondary battery, whereas the first and second active material layers may be formed of materials which function as active materials of the lithium ion secondary battery. Specifically, the invention can be suitably applied in manufacturing an electrode for battery as a constituent component of the lithium ion secondary battery.

Note that the invention is not limited to the embodiment described above and various changes other than the aforementioned ones can be made without departing from the gist of the invention. For example, in the above embodiment, the active material layer is formed by the strip-shaped pattern elements having a rectangular cross-sectional shape, but the cross-sectional shape of the strip-shaped pattern elements is arbitrary without being limited to this.

Further, although the application liquids having the same composition are supplied to the application nozzles 11, 12 and the active material layers having the same composition are formed on the both surfaces of the sheet S in the above embodiment, the technical concept described above can be applied also in the case where active material layers having different compositions are formed on both surfaces of a sheet. Specifically, the “first application liquid” and the “second application liquid” of the invention may have mutually different compositions.

Further, an insulating sheet formed with a positive electrode current collector layer and a negative electrode current collector layer respectively on both surfaces thereof may be used as the “sheet body” of the invention, and a positive active material layer as the “first active material layer” and a negative active material layer as the “second active material layer” may be respectively formed on a surface of the positive electrode current collector layer and on a surface of the negative electrode current collector layer. Even in such a configuration, since a structure is employ in which gap areas of the negative active material layer and gap areas of the positive active material layer are respectively complementarily reinforced from the opposite surfaces by the positive electrode active material layer and the negative electrode active material layer, it is possible to configure an electrode composite with high durability against a stress such as due to winding.

Further, although the above embodiment relates to the apparatus for manufacturing the electrode composite that functions as electrodes of lithium ion secondary batteries, an electrode for battery manufactured by the invention is not limited to the one used in lithium ion secondary batteries and electrodes used in other chemical batteries can also be manufactured by a similar principle.

According to the invention, it is possible to stably manufacture electrodes used in various chemical batteries besides those for lithium ion secondary batteries.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

What is claimed is:

1. A method for manufacturing an electrode for battery, comprising:
an arranging step of conveying a sheet body, which functions as a current collector, in a predetermined direction, causing a first nozzle with a plurality of first discharge ports arranged along a width direction of the sheet body perpendicular to the conveying direction of the sheet body to face a first principal surface of the sheet body and causing a second nozzle with a plurality of second discharge ports arranged along the width direction to face a second principal surface of the sheet body opposite to the first principal surface;
a first applying step of discharging a first application liquid containing an active material from each of the first discharge ports of the first nozzle to form a first active material layer including a plurality of first strip-shaped parts extending along the conveying direction on the first principal surface; and
a second applying step of discharging a second application liquid containing an active material from each of the second discharge ports of the second nozzle to form a second active material layer including a plurality of second strip-shaped parts extending along the conveying direction on the second principal surface,
wherein:
an area of the first principal surface of the sheet body corresponding to a gap between the second strip-shaped parts on the second principal surface is covered by one of the first strip-shaped parts; and
an area of the second principal surface of the sheet body corresponding to a gap between the first strip-shaped parts on the first principal surface is covered by one of the second strip-shaped parts.

2. The method according to claim 1, wherein the first nozzle and the second nozzle are arranged to each other across the sheet body and the first applying step and the second applying step are simultaneously performed.

3. The method according to claim 1, wherein a width of each of the plurality of first strip-shaped parts is larger than a maximum interval between the second strip-shaped parts on the second principal surface and a width of each of the plurality of second strip-shaped parts is larger than a maximum interval between the first strip-shaped parts on the first principal surface.

4. The method according to claim 1, further comprising a step of winding the sheet body formed with the first active material layer and the second active material layer around an axis perpendicular to the conveying direction.

5. An apparatus for manufacturing an electrode for battery, comprising:
a conveyor for conveying a sheet body which becomes a current collector;
a first nozzle which includes a plurality of first discharge ports arranged in a row to discharge a first application liquid containing an active material and is arranged such that an arrangement direction of the first discharge ports is perpendicular to a conveying direction of the sheet body conveyed by the conveyor and that each of the plurality of first discharge port faces a first principal surface of the sheet body; and
a second nozzle which includes a plurality of second discharge ports arranged in a row to discharge a second application liquid containing an active material and is arranged such that an arrangement direction of the second discharge ports is parallel to the arrangement direction of the first discharge ports and that each of the plurality of second discharge port faces a second principal surface of the sheet body opposite to the first principal surface,
wherein when the first discharge ports and the second discharge ports are projected onto a virtual plane perpendicular to the conveying direction, a range of an area corresponding to a gap part between two first discharge ports adjacent to each other is included in an opening range of one of the second discharge ports and a range of an area corresponding to a gap part between two second discharge ports adjacent to each other is included in an opening range of one of the first discharge ports in a direction parallel to the arrangement direction within the virtual plane of projection.

6. The apparatus according to claim 5, wherein the first discharge ports and the second discharge ports are located at the same position in the conveying direction.

7. The apparatus according to claim 5, wherein the first nozzle and the second nozzle are identically shaped.

8. The apparatus according to claim 5, wherein the conveyor includes a winder for winding the sheet body on which the first application liquid and the second application liquid are applied into a roll.

9. An electrode composite having such a structure that active material layers are formed on both surfaces of a current collector in the form of a long sheet, comprising:
a sheet body for functioning as the current collector;
a first active material layer including a plurality of first strip-shaped parts which extend in a longitudinal direction of the sheet body along a first principal surface of the sheet body and are arranged at a distance from each other in a direction perpendicular to the longitudinal direction; and
a second active material layer including a plurality of second strip-shaped parts which extend in the longitudinal direction along a second principal surface of the sheet body opposite to the first principal surface and are arranged at a distance from each other in a direction perpendicular to the longitudinal direction,
wherein:
an area of the first principal surface of the sheet body corresponding to a gap between the second strip-shaped parts on the second principal surface is covered by one of the first strip-shaped parts;
an area of the second principal surface of the sheet body corresponding to a gap between the first strip-shaped parts on the first principal surface is covered by one of the second strip-shaped parts; and
the electrode composite is wound into a roll around a winding axis perpendicular to the longitudinal direction.

10. The electrode composite according to claim 9, wherein a width of each of the plurality of first strip-shaped parts is larger than a maximum interval between the second strip-shaped parts on the second principal surface and a width of each of the plurality of second strip-shaped parts is larger than a maximum interval between the first strip-shaped parts on the first principal surface.

11. The electrode composite according to claim 9, wherein the sheet body is formed of a material which functions as a current collector of a lithium ion secondary battery and the first active material layer and the second active material layer are formed of materials which function as active materials of the lithium ion secondary battery.
